(19) United States
(12) Patent Application Publication
(10) Pub. No.: US 2019/0267636 A1
(43) Pub. Date: Aug. 29, 2019

(54) ENHANCING CATALYST ACTIVITY OF A PEM FUEL CELL ELECTRODE WITH AN IONIC LIQUID ADDITIVE

(71) Applicant: GM GLOBAL TECHNOLOGY OPERATIONS LLC, DETROIT, MI (US)

(72) Inventors: Anusorn Kongkanand, Rochester Hills, MI (US); Venkata Yarlagadda, Rochester, MI (US)

(21) Appl. No.: 15/906,301

(22) Filed: Feb. 27, 2018

(51) Int. Cl. H01M 4/88; H01M 4/92; H01M 8/1018

(52) U.S. Cl. CPC H01M 4/8892; H01M 4/926; H01M 2250/20; H01M 8/1018; H01M 2008/1095; H01M 4/8828

(57) ABSTRACT

A method of forming a catalyst-containing electrode layer for a polymer electrolyte membrane (PEM) fuel involves permeating an electrode layer with a liquid additive composition that comprises an ionic liquid additive and a carrier solvent. The electrode layer is then dried to remove the carrier solvent and deposit the ionic liquid additive within the electrode layer. The ionic liquid additive may be an organic cation of an ionic liquid, an organic anion of an ionic liquid, or both an organic cation and an organic anion of an ionic liquid. Once the electrode layer with its internal loading of the ionic liquid additive has been formed, a polymer electrolyte membrane fuel cell may be assembled such that the electrode layer constitutes either an anode layer or a cathode layer of the PEM fuel cell.

A polymer electrolyte membrane (PEM) fuel cell is an electrochemical device that converts the chemical energy of reductant and oxidant gasses into direct-current electricity and heat. The reductant gas may be hydrogen (H₂) and the oxidant gas may be air or oxygen (O₂). A PEM fuel cell includes a membrane-electrode assembly (MEA) where the electrochemical reactions of the fuel cell occur. The MEA includes a proton-conductive solid polymer electrolyte that supports an anode layer on one side and a cathode layer on the other side. A gas diffusion media layer is disposed on each side of the MEA, and an electrically-conductive plate in the form of a bipolar plate or an end plate is disposed outside each of the gas diffusion media layers. During operation of a PEM fuel cell, hydrogen gas is delivered to the anode layer of the MEA and air or oxygen is delivered to the cathode layer. The hydrogen gas is dissociated at the anode layer to generate free protons and electrons. The protons migrate through the proton-conductive solid polymer electrolyte and the electrons are directed around the electrolyte and through an external load to perform work. The protons and electrons eventually reach the cathode layer where they react with oxygen to generate water. In many instances, including for vehicle propulsion applications, a multitude of PEM fuel cells are arranged into a fuel cell stack to obtain increased voltage and power outputs.

Each of the anode and cathode layers of a PEM fuel cell MEA has conventionally included a catalyst dispersed in an ionomer binder. The catalyst typically includes finely-divided catalyst nanoparticles loaded onto a high-surface area carbon catalyst supports. The catalyst particles may be nanoparticles of a platinum group metal, such as platinum, or nanoparticles of a platinum group metal alloy, such as platinum-cobalt, to name but a few common examples. The carbon catalyst supports that carry the catalyst particles may be high-surface area carbon-structures such as carbon black particles, activated carbon particles, carbon nanotubes, carbon nanocages, as well as others. Currently, the catalyst content of the fuel cell electrode layers represents the largest cost associated with the manufacture of PEM fuel cells, especially since the catalyst nanoparticle loading for each electrode layer often ranges from 0.1 mgPt/cm² to 1.0 mgPt/cm² for a platinum-containing catalyst. Finding ways to reduce the catalyst content of one or both of the anode and cathode layers can thus help lower the cost and improve the commercial viability of vehicle power train systems that rely on PEM fuel cells to supply electric current to an on-board electric motor.

A number of ways to reduce catalyst usage—and, in particular, platinum catalyst usage—in PEM fuel cell electrode layers have been explored. Such efforts have begun to focus on improving the kinetics of the oxygen reduction reaction (ORR) promoted at the cathode layer since that electrochemical half-reaction is generally slower than the hydrogen oxidation reaction (HOR) promoted at the anode layer during normal PEM fuel cell operating conditions. For instance, alloying platinum with one or more transition metal elements and forming platinum-skinned or core-shell nanostructures are just a few concepts that have been investigated as a way to improve catalyst activity by optimizing the interaction between the catalyst nanoparticles and oxygen. These and other nanotechnological advances have had varying degrees of experimental, but not necessarily commercial, success. There is a continuing need to develop new and effective ways to enhance catalyst activity and fuel cell voltage performance so that, ultimately, lower catalyst amounts can be used in one or both of the anode and cathode layers.

### SUMMARY OF THE DISCLOSURE

A method of forming a catalyst-containing electrode layer for a polymer electrolyte membrane fuel cell according to one aspect of the present disclosure comprises several steps. In one step, a layer of an electrode ink composition is applied onto a surface of a substrate. The electrode ink composition comprises an ionomer and a catalyst dissolved or dispersed in a dispersion solvent. In another step, the layer of the electrode ink composition is dried to form an electrode layer having a thickness that ranges from 2 μm to 20 μm on the substrate. In yet another step, the electrode layer is permeated with a liquid additive composition that comprises an ionic liquid additive and a carrier solvent. And, in still another step, the electrode layer is dried after the electrode layer has been permeated with the liquid additive composition to remove the carrier solvent and deposit the ionic liquid additive within the electrode layer.

The method may further include the additional step of assembling a polymer electrolyte membrane fuel cell that incorporates the electrode layer. The polymer electrolyte membrane fuel cell includes a proton-conductive solid polymer electrolyte membrane sandwiched between an anode layer configured to receive hydrogen gas and a cathode layer configured to receive oxygen gas, a first gas diffusion media layer overlying the anode layer, a second gas diffusion media layer overlying the cathode layer, a first electrically-conductive flow field plate overlying the first gas diffusion media, and a second electrically-conductive flow field plate overlying the second gas diffusion media. The electrode layer may constitute either the anode layer or the cathode layer.

The substrate on which the electrode ink composition is applied may assume any of a wide variety of variations. For example, the substrate may be the proton-conductive solid polymer electrolyte membrane. In another example, the substrate may be the first gas diffusion media layer or the second gas diffusion media layer. In still another example, the substrate may be a decal substrate. If the substrate is a decal substrate, the step of assembling the polymer electrolyte fuel cell may further comprise the step of transferring the electrode layer from the decal substrate onto a face of the proton-conductive solid polymer electrolyte membrane.

The ionic liquid additive included in the liquid additive composition may be any of a number of possibilities. In one implementation, the ionic liquid additive is an organic cation of an ionic liquid. For example, the organic cation of an ionic liquid may include at least one of 7-methyl-1,5,7-triazabicyclo[4.4.0]dec-5-ene; 1-butyl-1-methylpiperidinium; or 1,1,3,3-tetramethylguanidine. In another implementation, the ionic liquid additive is an organic anion of an ionic liquid. For example, the organic anion may include bis(perfluoroethylsulfonyl)imide. In yet another implementation, the ionic liquid additive is both an organic cation of an ionic liquid and an organic anion of an ionic liquid. For example, the organic cation of an ionic liquid may include at least one of 7-methyl-1,5,7-triazabicyclo[4.4.0]dec-5-ene; 1-butyl-1-methylpiperidinium; or 1, 1,3,3-tetramethylguanidine, and the organic anion of an ionic liquid may include bis(perfluoroethylsulfonyl)imide.

The method may include additional steps or be further defined. For instance, the method may include the additional step of repeating, at least once, the permeating step and the drying step to deposit additional ionic liquid additive within the electrode layer. Indeed, the permeating step and the drying step may be performed initially to deposit within the electrode layer one of an organic cation of an ionic liquid or an organic anion of an ionic liquid, and, subsequently, the permeating step and the drying step may be performed to deposit within the electrode layer the other of an organic cation of an ionic liquid or the organic anion of an ionic liquid. The catalyst included in the electrode layer may also comprise catalyst nanoparticles supported on carbon support structures, and the electrode layer may have an ionic liquid additive internal loading, as expressed in a weight ratio of the ionic liquid additive to carbon of the carbon support structures of the catalyst, that ranges from 0.03 to 0.50.

A method of forming a catalyst-containing electrode layer for a polymer electrolyte membrane fuel cell according to one aspect of the present disclosure comprises several steps. In one step, an electrode layer is provided. The electrode layer is supported on a substrate and includes a catalyst dispersed in an ionomer binder. The catalyst comprises catalyst nanoparticles supported on carbon support structures. In another step, the electrode layer is permeated with a liquid additive composition that comprises an ionic liquid additive and a carrier solvent. The ionic liquid additive is an organic cation of an ionic liquid, an organic anion of an ionic liquid, or both an organic cation and an organic anion of an ionic liquid. In yet another step, the electrode layer is dried after the electrode layer has been permeated with the liquid additive composition to remove the carrier solvent and deposit the ionic liquid additive within the electrode layer. And, in still another step, a polymer electrolyte membrane fuel cell is assembled that includes a proton-conductive solid polymer electrolyte membrane sandwiched between the electrode layer disposed on one face of the polymer electrolyte membrane as a cathode layer and another electrode layer disposed on an opposite face of the polymer electrolyte membrane as an anode layer. The electrode layer that includes the ionic additive has an ionic liquid additive internal loading, as expressed in a weight ratio of the ionic liquid additive to carbon of the carbon support structures of the catalyst, that ranges from 0.03 to 0.50.

The method may include additional steps or be further defined. For example, the step of providing the electrode layer may involve preparing the electrode layer by, for example, applying a layer of an electrode ink composition onto a surface of a substrate and then drying the layer of the electrode ink composition to form the electrode layer on the substrate. The electrode ink composition may comprise an ionomer and a catalyst dissolved or dispersed in a dispersion solvent. In another implementation of the method, the permeating step and the drying step may be repeated at least once to deposit additional ionic liquid additive within the electrode layer. Indeed, the permeating step and the drying step may be performed initially to deposit within the electrode layer one of an organic cation of an ionic liquid or an organic anion of an ionic liquid, and, subsequently, the permeating step and the drying step may be performed to deposit within the electrode layer the other of an organic cation of an ionic liquid or the organic anion of an ionic liquid.

The ionic liquid additive included in the liquid additive composition may be any of a number of possibilities. In one implementation, the ionic liquid additive includes an organic cation of an ionic liquid or an organic anion of an ionic liquid. In that regard, the ionic liquid additive may include an organic cation of an ionic liquid and an organic anion of an ionic liquid. The organic cation of an ionic liquid may include at least one of 7-methyl-1,5,7-triazabicyclo[4.4.0]dec-5-ene; 1-butyl-1-methylpiperidinium; or 1,1,3,3-tetramethylguanidine, and the organic anion of an ionic liquid may include bis(perfluoroethylsulfonyl)imide.

### BRIEF DESCRIPTION OF THE DRAWINGS

FIG. 1 is a schematic cross-sectional view of a liquid additive composition being applied to an electrode layer, which has been applied to a substrate, to permeate the electrode layer with the liquid additive composition according to one aspect of the present disclosure;

FIG. 2 is a schematic cross-sectional view of a polymer electrolyte membrane fuel cell that includes a membrane-electrode-assembly, a pair of gas diffusion media layers, and a pair of electrically-conductive gas flow plates, and wherein at least one of an anode layer or a cathode layer of the membrane-electrode-assembly includes an ionic liquid additive and is prepared in accordance with practices of the present disclosure;

FIG. 3 is a schematic illustration of one embodiment of the present disclosure in which the substrate upon which the electrode layer has been applied in FIG. 1 is a proton-conductive solid polymer electrolyte membrane;

FIG. 4 is a schematic illustration of one embodiment of the present disclosure in which the substrate upon which the electrode layer has been applied in FIG. 1 is a gas diffusion media layer;

FIG. 5 is a schematic illustration of one embodiment of the present disclosure in which the substrate upon which the electrode layer has been applied in FIG. 1 is a decal substrate that is designed to allow the electrode layer to be subsequently transferred to a face of a proton-conductive solid polymer electrolyte membrane; and

FIG. 6 is a plot of three polarization curves in which voltage (in Volts (V)) is represented on the y-axis and current density (in amperes per centimeter squared (A/cm²)) is represented on the x-axis, and wherein one of the polarization curves represents a conventional cathode layer and the other two represent cathode layers that include an internal loading of an ionic liquid additive according to practices of the present disclosure.

### DETAILED DESCRIPTION

A method of forming a catalyst-containing electrode layer for a polymer electrolyte membrane (PEM) fuel cell is disclosed. The method involves permeating an electrode layer, which has been applied to and is supported on a substrate, with a liquid additive composition that includes an ionic liquid additive and a carrier solvent. The electrode layer is then dried to remove the carrier solvent and deposit the ionic liquid additive within the electrode layer. The ionic liquid additive may be an organic cation of an ionic liquid, an organic anion of an ionic liquid, or both an organic cation and an organic anion of an ionic liquid. The process of permeating the electrode layer with a liquid additive composition and then drying the electrode layer may be performed once or more than once to provide the electrode layer with an ionic liquid additive internal loading. The electrode layer may be employed as an anode layer or a cathode layer of an assembled PEM fuel cell. The other of the anode layer or the cathode layer may be prepared in the same manner, if desired, or it may prepared without the addition of an ionic liquid additive. The internal deposition of the ionic liquid additive within the electrode layer enhances the catalyst activity of the electrode layer under PEM fuel cell operating conditions by optimizing the interface between catalyst particles and the binding ionomer.

The term “ionic liquid” as used herein refers to a salt that is liquid at 100° C. or less due to poor coordination between the salt ions as a result of one or both of the ions being relatively large in size. In other words, the salt has a melting point of 100° C. or less and, preferably, somewhere between 5° C. and 70° C. Ionic liquids do not decompose or vaporize when melted, and typically exhibit a low vapor pressure when in the liquid state. The “ionic liquid additive” that is introduced into and deposited internally within the electrode layer as part of the disclosed method may include an organic cation of an ionic liquid, an organic anion of an ionic liquid, or it may include both an organic cation and an organic anion of an ionic liquid. When the ionic liquid additive is both an organic cation and an organic anion of an ionic liquid, the two ions may be permeated into the electrode layer together as an ionic liquid disseminated within a carrier solvent, or, they may be permeated into the electrode layer separately if the ionic liquid formed by their combination has too high of a viscosity, has poor wetability, or suffers from some other detriment. The “ionic liquid additive” deposited within the electrode layer is thus an ionic liquid or an organic ion that can form an ionic liquid.

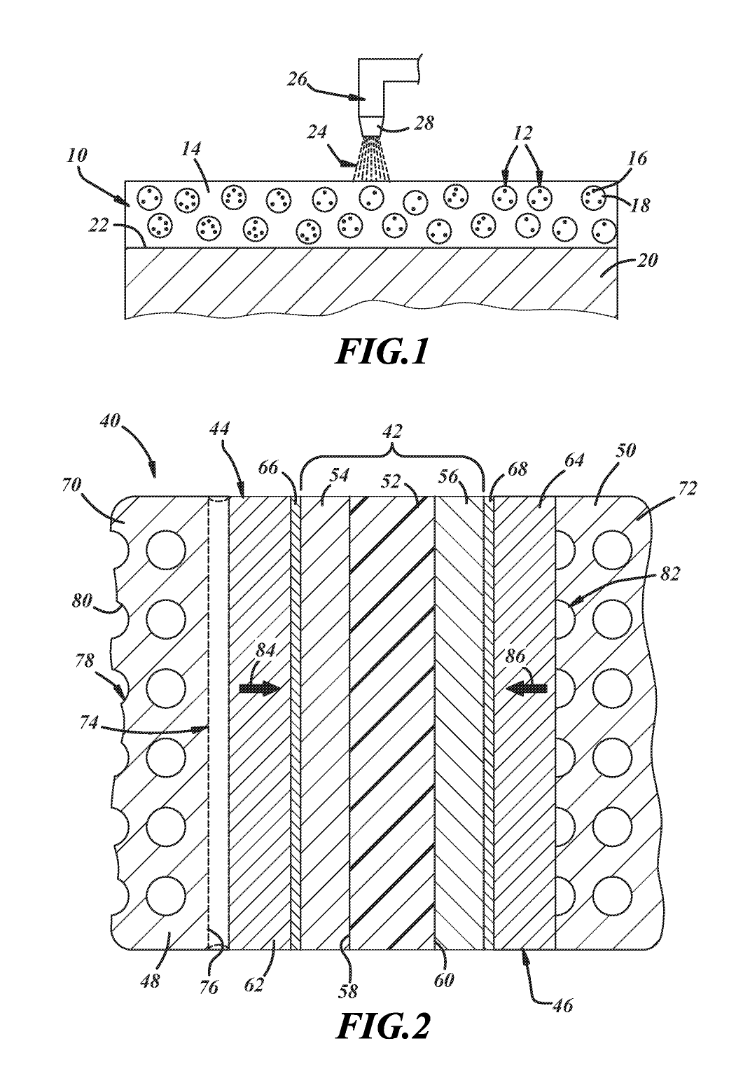

Referring now to FIG. 1, a schematic depiction of an embodiment of the disclosed method is illustrated. The method involves providing electrode layer 10 that includes a catalyst 12 dispersed in an ionomer binder 14. The catalyst 12 preferably comprises catalyst nanoparticles 16 supported on electrically-conductive carbon support structures 18. The catalyst nanoparticles 16 may be nanoparticles of a platinum group metal, such as platinum, or nanoparticles of a platinum group metal alloy, such as platinum-cobalt, to name but a few common examples. Typically, the catalyst nanoparticles 16 have diameters that range from 1.0 nm to 10 nm. As for the carbon support structures 18 that carry the catalyst nanoparticles 16, they may be high-surface area carbon-structures such as carbon black particles (e.g., Vulcan black XC-72R, Ketjen black EC-300J, acetylene black, etc.), activated carbon particles, carbon nanotubes, and carbon nanocages, among others. In one specific example, the catalyst 12 may comprise platinum nanoparticles supported on carbon black particles and, in particular, Ketjen black EC-300J. However composed, the catalyst 12 operates to accelerate one of the following two electrochemical half reactions that transpire within a PEM fuel cell depending on whether the electrode layer 10 will ultimately function as an anode layer or a cathode layer:

2H₂→4H⁺+4e⁻ (hydrogen oxidation half-reaction at the anode layer)

O₂+4H⁺+4e⁻→2H₂O (oxidation reduction half-reaction at the cathode layer)

2H₂+O₂→2H₂O (net redox reaction)

The ionomer binder 14 supports and binds the catalyst 12 while also providing proton conductivity. The ionomer binder 14 is composed of a proton-conductive polymer. A sulfonated fluoropolymer is one particular group of proton-conductive polymers that may constitute the ionomer binder 14. For example, the sulfonated fluoropolymer may be a copolymer that has a polytetrafluoroethylene (PTFE) backbone with perfluoroether pendant side chains that terminate in sulfonic acid groups. Some examples of such sulfonated fluoropolymers include Nafion® and Aquivion®, which are represented below by formulas (1) and (2), respectively:

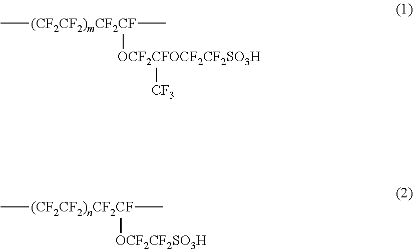

Other proton-conductive polymers besides sulfonated fluoropolymers may also constitute the ionomer binder 14, including those that have a PTFE backbone with perfluoroether pendant side chains that terminate in carboxylic acid groups instead of sulfonic acid groups. In many instances, the electrode layer 10 includes 30 wt % to 80 wt % of the catalyst 12 and 20 wt % to 70 wt % of the ionomer binder 14. Additionally, the loading of the catalyst nanoparticles 16 within the electrode layer 10 may be in the range of 0.02 mg/cm' to 0.2 mg/cm².

The electrode layer 10 is supported on a substrate 20. The substrate 20 may be any of a wide variety of supporting substrates that presents a relatively flat receiving surface 22 for application of the electrode layer 10. For example, as will be discussed in more detail below, the substrate 20 may be a proton-conductive solid polymer electrolyte, a gas diffusion media layer, or a decal substrate. One way to provide the electrode layer 10 is to derive the electrode layer 10 from an electrode ink composition that comprises an ionomer and the catalyst 12 dissolved or dispersed in a dispersion solvent. The ionomer is what becomes the ionomer binder 14 and, therefore, is preferably a sulfonated fluoropolymer in dissolvable or colloidal form. The electrode ink composition may be prepared by mixing the catalyst, in powder form, into an ionomer solution that includes the ionomer dissolved or dispersed in a mixture of a water and an aliphatic alcohol such as, for example, 10 wt % to 90 wt % water and 10 wt % to 90 wt % ethanol, n-propanol, or isopropanol. The ionomer solution may be prepared from its individual ingredients or it may be acquired from a commercial source. One specific commercially-available ionomer solution that is useful in preparing the electrode ink composition is designated D2020 and can be obtained from The Chemours Company. The D2020 ionomer solution includes 20-22 wt % 1000 EW Nafion® dissolved in a solvent mixture that includes 42 wt % to 50 wt % n-propanol and 30 wt % to 38 wt % water.

Once prepared, the electrode ink composition may include 1 wt % to 10 wt % of the ionomer, 1 wt % to 10 wt % of the catalyst 12, and 80 wt % to 95 wt % of the dispersion solvent. The electrode ink composition is then applied to the receiving surface 22 of the substrate 20 to form a wet electrode precursor layer. This wet layer is usually 10 μm to 150 μm thick, and is typically applied to the substrate 20 by casting, although other application techniques capable of forming the electrode ink composition into thin layer may also be used. After the electrode ink composition has been applied to the receiving surface 22 of the substrate, the wet electrode precursor is dried to remove the dispersion solvent. Such drying often involves maintaining the wet electrode precursor layer in a heated environment of 25° C. to 90° for a period of time ranging from 1 minute to 10 minutes. The removal of the dispersion solvent from the wet electrode precursor layer ultimately transforms the precursor layer into the electrode layer 10. In addition to comprising the catalyst 12 and the ionomer binder 14, as discussed above, the electrode layer 10 preferably has a porosity of 50% to 80% and a thickness that ranges from 2 μm to 20 μm.

The electrode layer 10 is permeated with a liquid additive composition 24 after being provided on the substrate 20. The liquid additive composition 24 includes an ionic liquid additive dissolved or dispersed within a carrier solvent. The ionic liquid additive may be a cation of an ionic liquid, an anion of an ionic liquid, or both a cation and an anion of an ionic liquid, as previously explained. The carrier solvent that carries a disseminated amount of the ionic liquid additive may be a mixture of a water and an aliphatic alcohol such as, for example, 10 wt % to 90 wt % water and 10 wt % to 90 wt % ethanol, isopropanol, and/or n-propanol. The liquid additive composition 24 may include anywhere from 0.05 wt % to 80 wt % of the ionic liquid additive and anywhere from 20 wt % to 95 wt % of the carrier solvent, and may be applied to the electrode layer 10 by a spray apparatus 26 or any other type of liquid application device. In one particular embodiment, the spray apparatus 26 may be a nitrogen-pressurized airbrush spray gun that can spray the liquid additive composition through an outlet nozzle 28 at an outlet pressure of 5 psi to 50 psi. The number of coating passes and the coating speed of the spray gun may be adjusted accordingly to ensure good coverage.

A number of organic cations and/or organic anions of an ionic liquid may constitute the ionic liquid additive of the liquid additive composition 24. Preferred organic cations of an ionic liquid that may be present in the liquid additive composition 24 are 7-methyl-1,5,7-triazabicyclo[4.4.0]dec-5-ene (also known as “MTBD”); 1-butyl-1-methylpiperidinium; and 1,1,3,3-tetramethylguanidine. The chemical formulas of those three organic cations are illustrated below as formulas (I), (II), and (III), respectively. Moreover, a preferred organic anion of an ionic liquid that may be present in the liquid additive composition is bis(perfluoroethylsulfonyl)imide (also known as “beti”). The chemical formula of this particular organic anion is illustrated below as formula (IV).

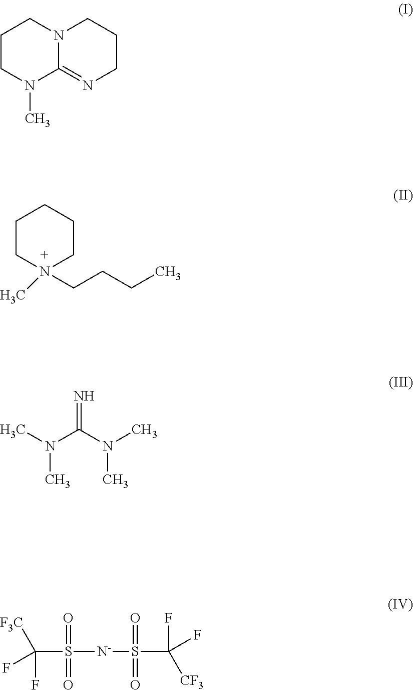

The ionic liquid additive in the liquid additive composition 24 may include (1) one or more of the above-listed organic cations without any organic anions of an ionic liquid or (2) the organic anion above-listed anion without any organic cations of an ionic liquid. In each of these instances, the organic cations or organic anions may be accompanied by counterions if desired. Suitable counterions for the organic cations of an ionic liquid include tetrafluoroborate (BF₄⁻) or perchlorate (ClO₄⁻) anions, and suitable counterions for the organic anions of an ionic liquid include lithium cations (Li⁺). The ionic liquid additive in the liquid additive composition 24 may also include (3) one or more of the above-listed organic cations and the above-listed organic anion. For instance, in one particular embodiment, the ionic liquid additive in the liquid additive composition 24 may be [MTBD] [beti].

The liquid additive composition 24 permeates into and spreads throughout the electrode layer 10 as a result of the porosity of the electrode layer 10 and the mobility of the additive composition 24 as provided by the carrier solvent. Consequently, the ionic liquid additive is distributed internally throughout the electrode layer 10 and, in fact, is believed to wet and coat the catalyst nanoparticles 16 of the catalyst 12. Following the application of the liquid additive composition 24 to the electrode layer 10 by the spray apparatus 26 or otherwise—and the resultant permeation of the electrode layer 10 with the liquid additive composition 24—the electrode layer 10 is dried to remove the carrier solvent and deposit the ionic liquid additive within the electrode layer 10. Such drying of the electrode layer 10 preferably involves maintaining the electrode layer 10 in a heated environment of 25° C. to 80° C. for a period of time ranging from 1 minute to 10 minutes. By driving off the carrier solvent, the ionic additive is deposited as an internal residue that tends to coat the catalyst nanoparticles 16 of the catalyst 12 to a thickness of 0.3 nm to 2.0 nm. The deposited ionic liquid additive is believed to optimize the interface between the catalyst nanoparticles 16 and the ionomer binder 14 which, in turn, contributes to improved activity of the catalyst 12.

The permeation of the electrode layer with the liquid additive composition 24 and the subsequent drying of the electrode layer 10 may be performed once. In an alternative implementation of the disclosed method, however, the permeation of the electrode layer with the liquid additive composition 24 and the subsequent drying of the electrode layer 10 may be repeated at least one additional time to deposit additional ionic liquid additive of the same or different variety within the electrode layer 10. The permeation and drying steps may be performed more than once when, for example, the desired ionic liquid additive is an ionic liquid that includes an organic cation and an organic anion, but the chosen ionic liquid cannot be effectively permeated into the electrode layer 10 by way of the liquid additive composition 24 because the ionic liquid is too viscous, has poor wettability, or suffers from some other detriment. In that regard, the disclosed process is quite flexible in that it can, if desired, deposit an ionic liquid additive that includes both an organic cation of an ionic liquid and an organic anion of an organic liquid within the electrode layer 10 when, practically, the ionic liquid itself that is formed by the two ions could not be deposited in a single application step.

In one specific implementation in which multiple permeation and drying steps are performed, a first liquid additive composition 24 may initially include one of an organic cation of an ionic liquid or an organic anion of an ionic liquid as the ionic liquid additive. The first liquid additive composition 24 is then permeated into the electrode layer 10 and dried, as described above, to deposit the organic cation/anion of an ionic liquid within the electrode layer 10. Next, a second liquid additive composition 30 that includes, as the ionic liquid additive, the other of the organic cation of an ionic liquid or the organic anion of an ionic liquid that ionically complements the organic cation/anion previously-deposited within the electrode layer 10 is permeated into the electrode layer 10 and dried. The end result is that the ionic liquid additive deposited within the electrode layer 10 includes both the organic cation and the organic anion of an ionic liquid, albeit deposited by way of separate liquid additive compositions 24, 30. In a variation to the separate deposition of an organic cation of an ionic liquid and an organic anion of an ionic liquid just described, the first liquid additive composition 24 and the second liquid additive composition may be permeated into electrode layer 10 sequentially or simultaneously, followed by drying of the electrode layer 10 deposit the organic cation and the organic anion of an ionic liquid at the same time.

The amount of the ionic liquid additive that is deposited within the electrode layer 10—either by a single liquid additive composition 24 or multiple liquid additive compositions 24, 30—may be controlled to achieve an ionic liquid additive internal loading within the electrode layer 10. The ionic liquid additive may be expressed as a weight ratio of the ionic liquid additive to the carbon provided by the carbon support structures 18 of the catalyst 12. In other words, the ionic liquid additive internal loading is determined by dividing the weight of the internally-deposited ionic liquid additive (i.e., the total weight of the organic cation(s) of an ionic liquid and/or the organic anion(s) of an ionic liquid) by the weight of the carbon support structures 18 included in the catalyst 12 that is dispersed within the ionomer binder 14. In a preferred embodiment, the ionic liquid additive internal loading of the electrode layer ranges from 0.03 to 0.50. This internal loading range can enhance PEM fuel cell voltage output over a wide range of current densities, especially when employed as a cathode layer of a membrane-electrode assembly, compared to a conventional electrode layer that does not include an internally-deposited ionic liquid additive.

A polymer electrolyte membrane (PEM) fuel cell 40 may be assembled that includes the electrode layer 10, as depicted in FIG. 2. The PEM fuel cell 40 includes a membrane-electrode-assembly (MEA) 42 compressed between a first gas diffusion media layer 44 and a second gas diffusion media layer 46 and, outside of the gas diffusion media layers 44, 46, a first electrically-conductive flow field plate 48 and a second electrically-conductive flow field plate 50. The MEA 42 includes a proton-conductive solid polymer electrolyte membrane 52 sandwiched between an anode layer 54 and a cathode layer 56. The proton-conductive solid polymer electrolyte membrane 52 includes a first face 58 and an opposed second face 60, and is composed of an ionomer such as, for example, a sulfonated fluoropolymer as described above in connection with the ionomer binder 14 or any other proton-conductive polymer. The proton-conductive solid polymer electrolyte membrane 52 is an electrical insulator that allows protons to migrate through its thickness. The anode layer 54 overlies and contacts the first face 58 of the proton-conductive solid polymer electrolyte 52 and the cathode layer 56 overlies and contacts the second face 60. The primary functions of the anode layer 54 and the cathode layer 56 are to accelerate the hydrogen oxidation half-reaction (HOR) and the oxygen reduction half-reaction (ORR), respectively.

The electrode layer 10 with its ionic liquid additive internal loading may be employed as the anode layer 54 only, the cathode layer 56 only, or both the anode layer 54 and the cathode layer 56. Preferably, the electrode layer 10 is employed at least as the cathode layer 56 since the oxygen reduction half-reaction that occurs at the cathode layer 56 oftentimes proceeds at a slower rate than the hydrogen oxidation half-reaction and, therefore, can limit the voltage output of the cell. The electrode layer 10 may be incorporated into the PEM fuel cell 40 as either or both of the electrode layers 54, 56 by any appropriate procedure, several of which are described in more detail below. If only one of the anode layer 54 or the cathode layer 56 is provided by the electrode layer 10 with its ionic liquid additive internal loading, the other electrode layer 54, 56 on the opposite face of the proton-conductive solid polymer electrolyte membrane 52 may be a conventional electrode layer that includes catalyst nanoparticles supported on electrically-conductive carbon support particles that are dispersed in an ionomer binder. The catalyst nanoparticles, carbon support particles, and the ionomer binder of the conventional electrode layer may be the same as described above in connection with the electrode layer 10 depicted in FIG. 1 minus the internally-deposited ionic liquid additive.

The first and second gas diffusion media layers 44, 46 are disposed on opposite sides of the MEA 42 inward of the first and second electrically-conductive flow field plates 48, 50. The first gas diffusion media layer 44 overlies the anode layer 54 and the second gas diffusion layer 50 overlies the cathode layer. Each of the first and second gas diffusion media layers 44, 46 may comprise a diffusion media 62, 64 along with an optional microporous layer 66, 68. The diffusion media 62, 64 may be carbon paper or carbon cloth, and the microporous layer 66, 68, if present, may be a layer of carbon nanoparticles dispersed within a hydrophobic binder such as polytetrafluoroethylene (PTFE). The first and second gas diffusion media layers 62, 64 operate to evenly distribute hydrogen gas to the anode layer 54 and oxygen gas or air to the cathode layer 56, help manage water within the MEA 42, conduct heat and electricity between the MEA 42 and the electrically-conductive flow field plates 48, 50, and support the compressive forces applied to the PEM fuel cell 40.

The first and second electrically-conductive flow field plates 48, 50 are disposed adjacent to the first and second gas diffusion media layers 44, 46 opposite the MEA 42. The first electrically-conductive flow field plate 48 overlies the first gas diffusion media layer 44 and the second electrically-conductive flow field plate 50 overlies the second gas diffusion media layer 46. Each of the first and second electrically-conductive flow field plates 48, 50 may be a bipolar plate 70 or, alternatively, one of the first or second electrically-conductive flow field plates 48, 50 may be a bipolar plate 70 and the other of the first or second electrically-conductive flow field plates 48, 50 may be an end plate 72. For purposes of illustration only, the first electrically-conductive flow field plate 70 is depicted in FIG. 2 as a bipolar plate and the second electrically-conductive flow field plate 50 is depicted as an end plate 72. The bipolar plate 70, as shown, defines a first gas flow field 74 having gas flow channels 76 (for delivering one of (1) hydrogen gas or (2) oxygen gas or air) on one side and a second gas flow field 78 having gas flow channels 80 (for delivering the other of (1) hydrogen gas or (2) oxygen gas or air) on the other side. In contrast, the end plate 72 defines only a first gas flow field 82 with gas flow channels on one side. Each of the bipolar plate 70 and the end plate 72 may additionally define internal cooling channels in which water is directed to remove heat from the PEM fuel cell 40 during operation. The first and second electrically-conductive flow field plates are typically composed of (1) a metal base plate that is optionally covered with a carbon coating or (2) graphite.

The operation of the PEM fuel cell 40 proceeds in the normal manner with the added benefits attributed to the ionic liquid additive internal loading of the electrode layer 10, which, again, is preferably employed at least as the cathode layer 56. Still referring to FIG. 2, the operation of the PEM fuel cell 40 includes directing hydrogen gas 84 to the anode layer 54 through the first gas diffusion media layer 44 and, at the same time, directing oxygen gas or air 86 to the cathode layer 56 through the second gas diffusion media layer 46. The hydrogen gas 84 is oxidized at the anode layer 54 to generate protons (W) and electrons. The protons migrate through the proton-conductive solid polymer electrolyte membrane 52 and the electrons are conducted back through the first gas diffusion media layer 44 to the first electrically-conductive flow field plate 48. The electrons are then directed through an external circuit (not shown) and around the proton-conductive solid polymer electrolyte membrane 52 to perform work. The protons migrating through the polymer electrolyte membrane 52 and the electrons traveling through the external circuit eventually arrive at the cathode layer 56. Once at the cathode layer 56 the oxygen supplied by the oxygen gas or air 86 is reduced in the presence of protons and electrons to produce water. This overall redox reaction is run continuously when there is a demand for electricity from the PEM fuel cell 40. And, oftentimes, as many as two hundred similar cells are arranged in a fuel cell stack to obtain the desired power output.

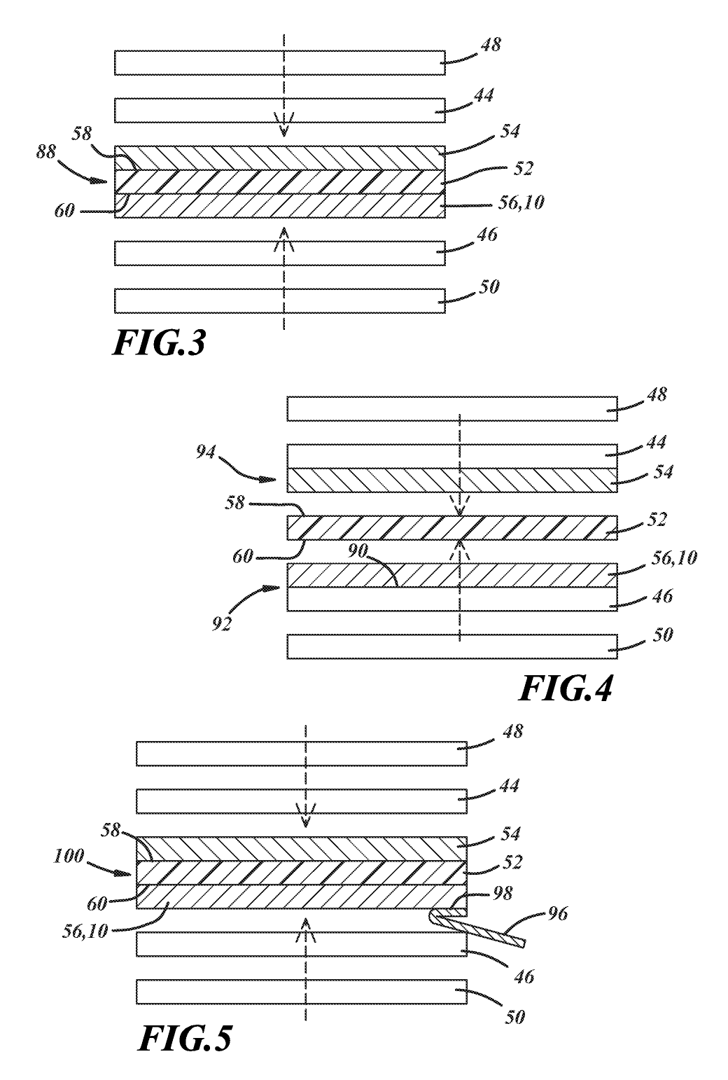

The assembly of the PEM fuel cell 40 to include the electrode layer 10 as the anode layer 54 and/or the cathode layer 56 can be carried out in numerous ways. Several examples are shown in FIGS. 3-5. In a first option, which is shown in FIG. 3, the substrate 20 upon which the electrode layer 10 is provided may be the proton-conductive solid polymer electrolyte membrane 52. Here, the anode layer 54 is applied over the first face 58 of the polymer electrolyte membrane 52 and the cathode layer 56 may be applied over the opposed second face 60 to form a catalyst-coated membrane (CCM) 88. Next, the anode layer 54, the cathode layer 56, or both the anode and cathode layers 54, 56 may be permeated with the liquid additive composition(s) 24, 30 and dried at least once, as described above in connection with the representative electrode layer 10, to internally deposit ionic liquid additive within the anode and/or cathode layers 54, 56. In FIG. 3, however, and only for illustrative purposes, the cathode layer 56 is designated as being treated with the liquid additive composition(s) 24, 30, while the anode layer 54 is constructed as a conventional electrode layer. Once the cathode layer 56 has been treated, the first gas diffusion media layer 44 is disposed over the anode layer 54 and the second gas diffusion media layer 46 is disposed over the catalyst layer 56, and the first electrically-conductive flow field plate 48 is disposed over the first gas diffusion media layer 44 and the second electrically-conductive flow field plate 50 is disposed over the second gas diffusion media layer 46 while assembling the PEM fuel 40.

In a second option, which is shown in FIG. 4, the substrate 20 upon which the electrode layer 10 is provided may be one of the gas diffusion media layers 44, 46. For instance, and as shown here for illustrative purposes, the cathode layer 56 is applied over a face 90 of the second gas diffusion media layer 46 to form a catalyst coated gas diffusion media layer 92. The microporous layer 68 may be omitted from the second gas diffusion media layer 46 to facilitate better adherence between the cathode layer 56 and the gas diffusion media layer 46. After the cathode layer 56 has been applied onto the second gas diffusion media layer 46, the cathode layer 56 is permeated with the liquid additive composition(s) 24, 30 and dried at least once, as described above in connection with the representative electrode layer 10, to internally deposit ionic liquid additive within the cathode layer 56. The catalyst coated gas diffusion media layer 92 and a similar catalyst coated gas diffusion media layer 94 that includes the anode layer 54 as a conventional electrode layer are then disposed against their respective second and first faces 60, 58 of the proton-conductive solid polymer electrolyte membrane 52 to form the MEA 42, and the first electrically-conductive flow field plate 48 is disposed over the first gas diffusion media layer 44 and the second electrically-conductive flow field plate 50 is disposed over the second gas diffusion media layer 46 while assembling the PEM fuel 40.

In a third option, which is shown in FIG. 5, the substrate 20 upon which the electrode layer 10 is provided may be a decal substrate 96. The decal substrate 96 has approximately the same length and width dimensions as the electrode layer 10 being formed and may be formed of fiberglass reinforced PTFE or poly(ethene-co-tetrafluoroethene) (ETFE) that has been treated with a Teflon release agent. Here, for illustrative purposes, the cathode layer 56 is shown being applied to a face 98 of the decal substrate 96. Once in place, the cathode layer 56 is permeated with the liquid additive composition(s) 24, 30 and dried at least once, as described above in connection with the representative electrode layer 10, to internally deposit ionic liquid additive within the cathode layer 56. The cathode layer 56 with its ionic liquid additive internal loading is then transferred to the proton-conductive solid polymer electrolyte membrane 52. The transfer of the cathode layer 56 involves positioning the coated decal substrate against the second face 60 of the solid polymer electrolyte membrane 52 with the cathode layer 56 facing the membrane 52. The coated decal substrate is then hot-pressed against the solid polymer electrolyte membrane 52 to transfer the cathode layer 56 onto the membrane 52. The coated decal substrate may be hot pressed at a temperature of 130° C. to 150° C. and a compression pressure of 230 kPaa to 270 kPaa for a duration of two minutes to ten minutes. Upon completion of the hot-pressing, the decal substrate is peeled away from the cathode layer 56, which remains adhered to and retained on the second face 60 of the solid polymer electrolyte membrane 52.

The anode layer 54 may be transferred onto the first face 58 of the proton-conductive solid polymer electrolyte membrane 52 in a similar manner to form a catalyst coated membrane (CCM) 100. That is, the anode layer 54 may be provided on a decal substrate and then transferred to the proton-conductive solid polymer electrolyte membrane 52 by hot-pressing, followed by peeling away the decal substrate such that the anode layer 54 remains adhered to and retained on the first face 58 of the electrolyte membrane 52. In FIG. 5, however, the anode layer 54 is depicted as a conventional electrode layer 54. Once the CCM 100 has been produced, the first gas diffusion media layer 44 is disposed over the anode layer 54 and the second gas diffusion media layer 46 is disposed over the catalyst layer 56, and the first electrically-conductive flow field plate 48 is disposed over the first gas diffusion media layer 44 and the second electrically-conductive flow field plate 50 is disposed over the second gas diffusion media layer 46 while assembling the PEM fuel 40.

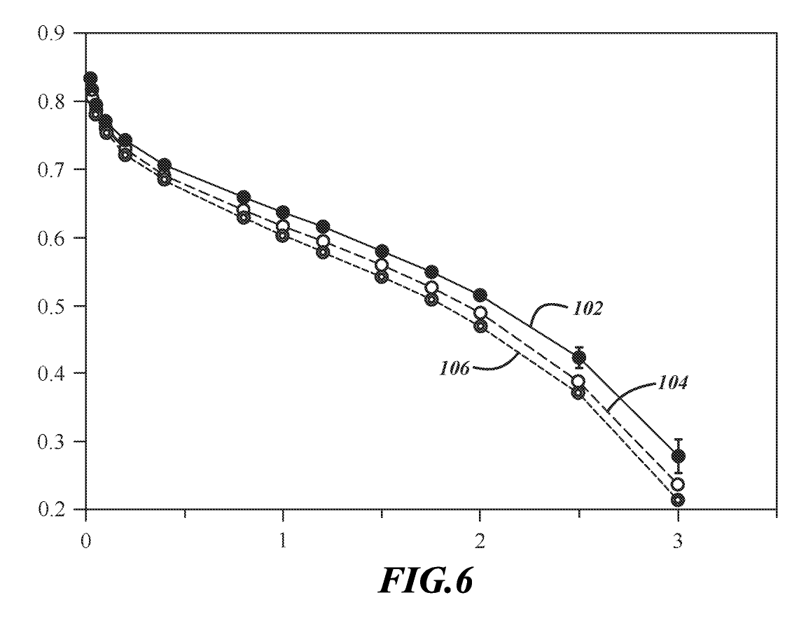

FIG. 6 demonstrates the performance enhancing effect that can be attributed to the internal deposition of the ionic liquid additive within an electrode layer during PEM fuel cell operating conditions, and, in particular, within a cathode layer of the PEM fuel cell. In FIG. 6, a polarization curve is shown for three PEM test fuel cells. The polarization curves shown here display the voltage output (y-axis in V) for the PEM test fuel cells as a function of current density (x-axis in A/cm²). For each test cell, the operating conditions included a temperature of 80° C., a relative humidity of 100%, a gas pressure of 150 kPaa, a platinum catalyst loading of 0.06 mg/cm², and a high stoichiometry flow rate of Hz/air to ensure the cell reactions were not limited by the availability of H₂ or O₂. Of the three PEM test cells displayed here in FIG. 6, two of them included a cathode layer having an internal deposition of an ionic liquid additive and one included a conventional cathode layer. The test cell identified by reference numeral 102 (test cell 1) had [MTBD][beti] internal loading of 0.024 mg/cm² and the test cell identified by reference numeral 104 (test cell 2) had a [beti] internal loading of 0.024 mg/cm². The test cell identified by reference numeral 106 (test cell 3) included the conventional electrode layer that did not include any internally-deposited ionic liquid additive.

As can be seen from the polarization curves displayed in FIG. 6, each of test cell 1 (102) and test cell 2 (104) had a better cell voltage performance than test cell 3 (106) from approximately a current density of 0.15 A/cm² and above. In fact, the voltage performance enhancement became more pronounced as the current density loading increased, with improvements over test cell 3 (106) of approximately 15 mV for test cell 2 (104) and 45 mV for test cell 1 (102) at an elevated current density of 2.5 A/cm². The improvement in cell voltage performance is believed to be a result of the internally-deposited ionic liquid additive and its capacity to optimize the interface between the catalyst nanoparticles and the ionomer binder. Moreover, internally depositing the ionic liquid additive as described herein, as opposed to simply mixing the ionic liquid additive into a dispersion solvent along with the ionomer and catalyst and then coating all of those components together into an electrode layer, is believed to yield better, more consistent, and more reliable gains in catalyst activity. This is because practices of the disclosed method do not risk having the ionic liquid additive washed away during preparation and application of the electrode ink composition.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

What is claimed is:

1. A method of forming a catalyst-containing electrode layer for a polymer electrolyte membrane fuel cell, the method comprising:
(a) applying a layer of an electrode ink composition onto a surface of a substrate, the electrode ink composition comprising an ionomer and a catalyst dissolved or dispersed in a dispersion solvent;
(b) drying the layer of the electrode ink composition to form an electrode layer having a thickness that ranges from 2 μm to 20 μm on the substrate;
(c) permeating the electrode layer with a liquid additive composition that comprises an ionic liquid additive and a carrier solvent; and
(d) drying the electrode layer after the electrode layer has been permeated with the liquid additive composition to remove the carrier solvent and deposit the ionic liquid additive within the electrode layer.

2. The method set forth in claim 1, further comprising:
assembling a polymer electrolyte membrane fuel cell that includes a proton-conductive solid polymer electrolyte membrane sandwiched between an anode layer configured to receive hydrogen gas and a cathode layer configured to receive oxygen gas, a first gas diffusion media layer overlying the anode layer, a second gas diffusion media layer overlying the cathode layer, a first electrically-conductive flow field plate overlying the first gas diffusion media, and a second electrically-conductive flow field plate overlying the second gas diffusion media, and wherein the electrode layer constitutes either the anode layer or the cathode layer.

3. The method set forth in claim 2, wherein the substrate is the proton-conductive solid polymer electrolyte membrane.

4. The method set forth in claim 2, wherein the substrate is the first gas diffusion media layer or the second gas diffusion media layer.

5. The method set forth in claim 2, wherein the substrate is a decal substrate, and wherein assembling the polymer electrolyte fuel cell further comprises:
transferring the electrode layer from the decal substrate onto a face of the proton-conductive solid polymer electrolyte membrane.

6. The method set forth in claim 1, wherein the ionic liquid additive includes an organic cation of an ionic liquid.

7. The method set forth in claim 6, wherein the organic cation of an ionic liquid includes at least one of 7-methyl-1,5,7-triazabicyclo[4.4.0]dec-5-ene; 1-butyl-1-methylpiperidinium; or 1,1,3,3-tetramethylguanidine.

8. The method set forth in claim 1, wherein the ionic liquid additive includes an organic anion of an ionic liquid.

9. The method set forth in claim 8, wherein the organic anion of an ionic liquid includes bis(perfluoroethylsulfonyl)imide.

10. The method set forth in claim 1, wherein the ionic liquid additive includes both an organic cation of an ionic liquid and an organic anion of an ionic liquid.

11. The method set forth in claim 10, wherein the organic cation of an ionic liquid includes at least one of 7-methyl-1,5,7-triazabicyclo[4.4.0]dec-5-ene; 1-butyl-1-methylpiperidinium; or 1,1,3,3-tetramethylguanidine, and wherein the organic anion of an ionic liquid includes bis(perfluoroethylsulfonyl)imide.

12. The method set forth in claim 1, further comprising:
(e) repeating steps (c) and (d) at least once to deposit additional ionic liquid additive within the electrode layer.

13. The method set forth in claim 12, wherein steps (c) and (d) are performed to deposit within the electrode layer one of an organic cation of an ionic liquid or an organic anion of an ionic liquid, and wherein step (e) is performed to deposit within the electrode layer the other of an organic cation of an ionic liquid or the organic anion of an ionic liquid.

14. The method set forth in claim 1, wherein the catalyst comprises catalyst nanoparticles supported on carbon support structures, and wherein the electrode layer has an ionic liquid additive internal loading, as expressed in a weight ratio of the ionic liquid additive to carbon of the carbon support structures of the catalyst, that ranges from 0.03 to 0.50.

15. A method of forming a catalyst-containing electrode layer for a polymer electrolyte membrane fuel cell, the method comprising:
(a) providing an electrode layer that is supported on a substrate and includes a catalyst dispersed in an ionomer binder, the catalyst comprising catalyst nanoparticles supported on carbon support structures;
(b) permeating the electrode layer with a liquid additive composition that comprises an ionic liquid additive and a carrier solvent, the ionic liquid additive being an organic cation of an ionic liquid, an organic anion of an ionic liquid, or both an organic cation and an organic anion of an ionic liquid; and
(c) drying the electrode layer after the electrode layer has been permeated with the liquid additive composition to remove the carrier solvent and deposit the ionic liquid additive within the electrode layer; and
(d) assembling a polymer electrolyte membrane fuel cell that includes a proton-conductive solid polymer electrolyte membrane sandwiched between the electrode layer disposed on one face of the polymer electrolyte membrane as a cathode layer and another electrode layer disposed on an opposite face of the polymer electrolyte membrane as an anode layer, and wherein the electrode layer that includes the ionic additive has an ionic liquid additive internal loading, as expressed in a weight ratio of the ionic liquid additive to carbon of the carbon support structures of the catalyst, that ranges from 0.03 to 0.50.

16. The method set forth in claim 15, wherein providing the electrode layer comprises:
(a1) applying a layer of an electrode ink composition onto a surface of a substrate, the electrode ink composition comprising an ionomer and a catalyst dissolved or dispersed in a dispersion solvent; and
(a2) drying the layer of the electrode ink composition to form the electrode layer on the substrate;

17. The method set forth in claim 15, wherein steps (b) and (c) are repeated at least once to deposit additional ionic liquid additive within the electrode layer.

18. The method set forth in claim 15, wherein steps (b) and (c) are performed to deposit within the electrode layer one of an organic cation of an ionic liquid or an organic anion of an ionic liquid, and wherein steps (b) and (c) are repeated at least once to deposit within the electrode layer the other of the organic cation of an ionic liquid or the organic anion of an ionic liquid.

19. The method set forth in claim 15, wherein the ionic liquid additive includes an organic cation of an ionic liquid or an organic anion of an ionic liquid.

20. The method set forth in claim 15, wherein the ionic liquid additive includes an organic cation of an ionic liquid and an organic anion of an ionic liquid, wherein the organic cation of an ionic liquid includes at least one of 7-methyl-1,5,7-triazabicyclo[4.4.0]dec-5-ene; 1-butyl-1-methylpiperidinium; or 1,1,3,3-tetramethylguanidine, and wherein the organic anion of an ionic liquid includes bis(perfluoroethylsulfonyl)imide.
